(19) United States
(12) Patent Application Publication
(10) Pub. No.: US 2025/0041874 A1
(43) Pub. Date: Feb. 6, 2025

(54) CLASSIFIER ARRANGEMENT FOR A VERTICAL ROLLER MILL

(71) Applicant: LOESCHE GmbH, Düsseldorf (DE)

(72) Inventor: Alexander MÜLLER, Berlin (DE)

(73) Assignee: LOESCHE GmbH, Düsseldorf (DE)

(21) Appl. No.: 18/720,435

(22) PCT Filed: Jan. 4, 2022
(86) PCT No.: PCT/EP2022/050053

§ 371 Date: Jun. 14, 2024

(51) Int. Cl. B02C 15/00; B07B 7/083

(52) U.S. Cl. CPC B02C 15/00; B07B 7/083; B02C 2015/002

(57) ABSTRACT

The invention relates to a classifier arrangement for a vertical roller mill having at least two classifiers. Each classifier has an active rotor which is rotatable about an axis of rotation. The axis of rotation is aligned at least at an angle of 50° to the vertical. The invention is characterized in that around each classifier a guide vane arrangement is provided at least partially surrounding the said classifier and having at least one guide vane. The guide vane has an open profile towards the axis of rotation. Furthermore, the invention relates to a vertical roller mill having a classifier arrangement according to the invention.

The invention relates to a classifier arrangement for a vertical roller mill which has at least two classifiers. These can be arranged in the same spatial plane. Each of the classifiers has an active rotor that is rotatable about an axis of rotation. The axis of rotation is aligned at least at an angle of 50° to the vertical. In particular, the axis of rotation is aligned horizontally.

Vertical roller mills mostly have a rotating grinding table, on which several stationary rotatable grinding rollers roll off. Grinding material to be comminuted is placed onto the grinding table and comminuted or crushed by means of the grinding rollers. Afterwards, the comminuted grinding material needs to the classified. In doing so, a distinction is made between sufficiently comminuted grinding material and so-called coarse material or grit which, following classification, is guided back onto the grinding table for a further comminution process.

The basic structure of a roller mill can be taken from WO 2011/107124 A1 or WO 2012/079605 A1 for example.

Generic classifiers have a classifier cage which is also referred to as rotor that is actively rotated about the axis of rotation. In principle, passive classifiers are also known in which classification is solely accomplished by deflecting an airflow or, more precisely, a dust-airflow. By way of the precise design of the classifier cage and its speed of rotation the classification limit can be influenced for example. This means that the grain size can be influenced, in the range of which separation is effected in the classification process. Grinding material that has larger grain sizes than the classification limit is rejected by the classifier by means of the classifier cage and supplied to further grinding.

A roller mill having several horizontally arranged classifiers is known from WO 2014/067688 for example.

Due to the ever increasing size of roller mills, in part also with an increasing number of rollers, which have a higher capacity and therefore process a greater throughput of grinding material, it is also necessary to improve the classifying units accordingly that are used to classify the ground grinding material so that these can also achieve a higher throughput. In addition, it must be taken into account that particularly in conjunction with vertical roller mills operated in recirculating air mode the air flows or currents generated by the rotors or classifier cages can partially have a negative effect on the overall air flow.

The invention is therefore based on the object to provide an efficient high-performance classifier arrangement.

In accordance with the invention this object is achieved by a classifier arrangement for a vertical roller mill having the features of claim 1.

Advantageous embodiments of the invention are stated in the subclaims, the description as well as in the Figures and their explanation.

In the classifier arrangement according to the invention provision is made in that around each classifier a guide vane arrangement is arranged at least partially surrounding the said classifier. Each guide vane arrangement has at least one guide vane, in which case each guide vane has an open profile towards the axis of rotation of the classifier.

The invention is based on the fundamental idea that the process air which is used to transport grinding material comminuted by the grinding rollers to the classifiers is specifically directed by means of the guide vanes onto the rotor or classifier cage. In this way, the flow angle of the process air and thus of the comminuted particles of grinding material transported with it can be influenced so that classification can be carried out more efficiently.

In addition, the guide vanes are designed such that they have a profile which is open towards the axis of rotation of the classifier. The advantage of this is that particles, which are rejected by the rotor because they are not yet sufficiently comminuted, can be collected in the open profile and then guided through gravity to the lower area of the classifier. This offers the advantage that particles rejected in such a way can be specifically guided to certain parts of the classifier or classifier arrangement instead of being hurled through the entire chamber in which the classifier or classifier cage is located. Due to the targeted guidance of the rejected particles that are too coarse the classifier can be operated more efficiently as there are fewer interfering influences.

According to the invention the classifiers can be arranged in the same spatial plane but also in different planes. In other words, an offset arrangement is also possible in which the classifiers are provided at different heights to the grinding table.

Basically, each classifier can be arranged with its axis of rotation as desired. By preference, however, the axis of rotation has a maximum angle of 20° to the horizontal, more preferably 10°, and can in particular be arranged horizontally. In contrast to vertically arranged classifiers the horizontal arrangement is particularly suited if several classifiers are intended for use. As a result, classifiers having an overall smaller size can be used, of which several are combined to a classifier arrangement.

The classifiers, more particularly their rotors, can have a substantially identical shape. For instance, this can be substantially cylindrical. However, other shapes, such as a conical basic shape, are possible too. The arrangement of identical classifiers facilitates the entire construction as well as spare parts storage.

In a preferred embodiment the axes of rotation of the classifiers are aligned with respect to each other and have a common point of intersection. It is also possible that the point of intersection is slightly enlarged so that an intersection area is present if the axes are not precisely aligned with respect to each other. Such an arrangement has proved to be advantageous as the classifying result can thereby be improved and the energy required to drive the classifiers can be reduced.

Advantageously, the guide vanes are arranged in a ring-shaped manner around the axis of rotation or the rotor. In other words, in a cylindrical rotor the guide vanes form a second cylindrical shell-shaped arrangement around the rotor itself.

In conjunction with this, a guide vane arrangement can have at least three guide vanes. By preference, a significantly greater number, up to twelve or twenty guide vanes are provided. The distance between adjacent guide vanes can in each case here be designed the same. The distance is chosen such that an intermediate space is present, through which the process air with the comminuted particles of grinding material can flow. In another embodiment the distance is designed differently. For instance, it can decrease or increase from the outside, i.e. the area of the mill housing, towards the inside, i.e. the center of the mill.

As described above the guide vanes have a profile which is open inwards towards the rotor and can have a V- or U-like cross section. In this case the tip or rounded side of the V- or U-like cross section faces outwards, i.e. away from the axis of rotation of the classifier. This allows inflowing air to be divided and guided easily past the guide vanes and led by them into a desired direction. In addition, the inwardly open profile is easy to design so that it can serve to collect and lead back rejected particles. According to the invention it is not absolutely necessary that the cross section or the profile of a guide vane is the same over its entire length. The cross section or the profile can also change. In addition, the cross section or the profiles of the guide vanes used can be different.

Basically, the guide vanes can here have different flanks in cross section. For example, if the guide vanes are designed with a V- or U-like cross section they mostly have two flanks, of which both do not have to be designed in the same way but one can also be designed longer than the other. This in turn makes it possible for carrier air or process air flowing through the guide vanes of the guide vane arrangement to be guided into a desired direction onto the rotor of the classifier.

It is advantageous if the guide vanes of the guide vane arrangement have an interruption in their ring shape. This serves the purpose that the particles rejected by the classifier can fall out of the open profiles and are conveyed to renewed grinding.

In this interruption guide plates can also be arranged. These are preferably arranged transversely to the direction of the guide vanes. On the one hand, the guide plates serve to further guide the inflowing carrier air. On the other hand, they offer the possibility to discharge the rejected particles falling out of the guide vanes in a guided direction.

Furthermore, the invention relates to a vertical roller mill having a classifier arrangement according to the invention.

Here, the number of classifiers of the classifier arrangement can correspond to the number of rollers provided for active grinding. Within the meaning of the invention active rollers can in particular be understood as rollers used to comminute the grinding material. Rolling mills are also known that have larger as well as smaller grinding rollers, in which case the smaller grinding rollers are often referred to as preparation rollers and are mainly used to prepare the grinding bed. They do not primarily serve to comminute the grinding material.

Providing the same number of classifiers as active grinding rollers has proved to be a good solution to achieve an energy-efficient classification as not a lot of small classifiers but nor few large classifiers have to be used in this case.

Depending on the grinding material and the space available in the housing the number of classifiers can also be greater or smaller than the number of active rollers.

By preference, the classifiers of the classifier arrangement are arranged in a star-shaped manner in the mill housing of the vertical mill. This means that they each have the same radial distance or angular distance to each other. Such an even distribution provides a good classification result because in a roller mill, in particular operated in recirculating air mode, ground particles are transported by the carrier air flow across the entire mill housing. What is more, in this way the space available in the mill housing can be optimally utilized. In certain embodiments it can also be advantageous to provide the classifiers with different angular distances to each other.

For all classifiers of the classifier arrangement a common grit funnel can be provided and below the interruptions of the guide vane arrangement chutes can be arranged that guide the rejected particles into the common grit funnel. In conjunction with this it is preferred that the interruptions in the guide vane arrangement are aligned towards the grinding chamber so that the rejected particles fall downwards in the direction of the grinding table or, if a common grit funnel is provided, fall into this due to gravity, making an additional transport unnecessary.

In specific embodiments it may also be advantageous if the classifier grits of each classifier are guided in individual chutes back onto the grinding table or even towards the outside of the grinding chamber. In the latter case the classifier grits are removed from the further grinding process in order to be supplied to further processing of a different kind.

The invention is explained in greater detail hereinafter by way of schematic exemplary embodiments with reference to the Figures, wherein show:

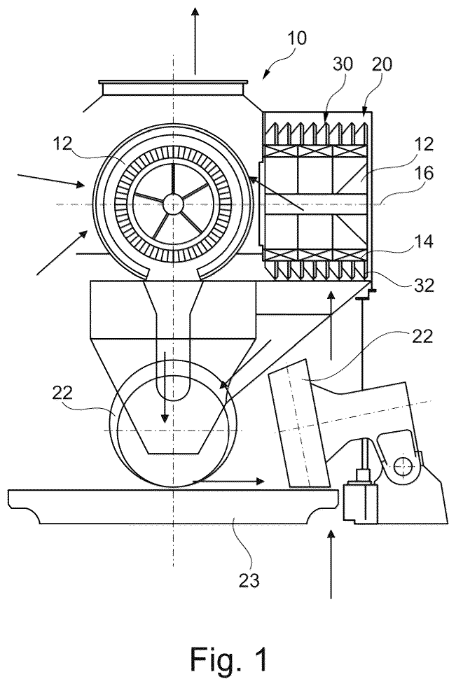

FIG. 1 a highly schematized view of a vertical roller mill with a classifier arrangement according to the invention, in partially sectional illustration;

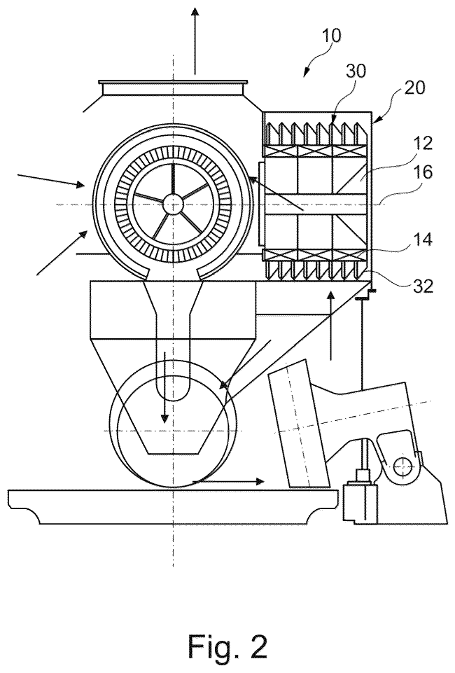

FIG. 2 a highly schematized view of a roller mill with a classifier arrangement according to the invention in another embodiment, in partially sectional illustration;

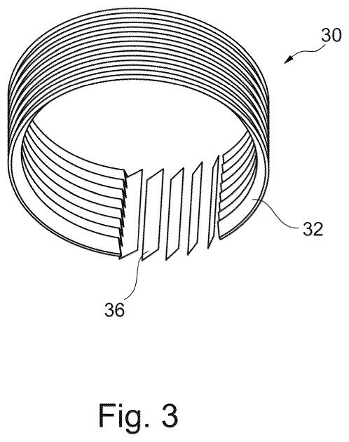

FIG. 3 a guide vane arrangement with guide plates;

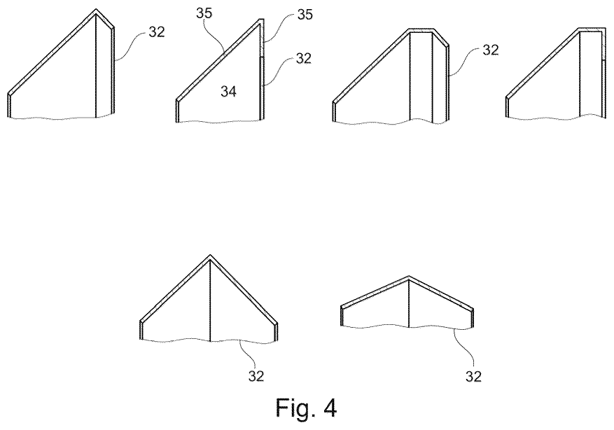

FIG. 4 different profiles for guide vanes of the guide vane arrangement according to the invention;

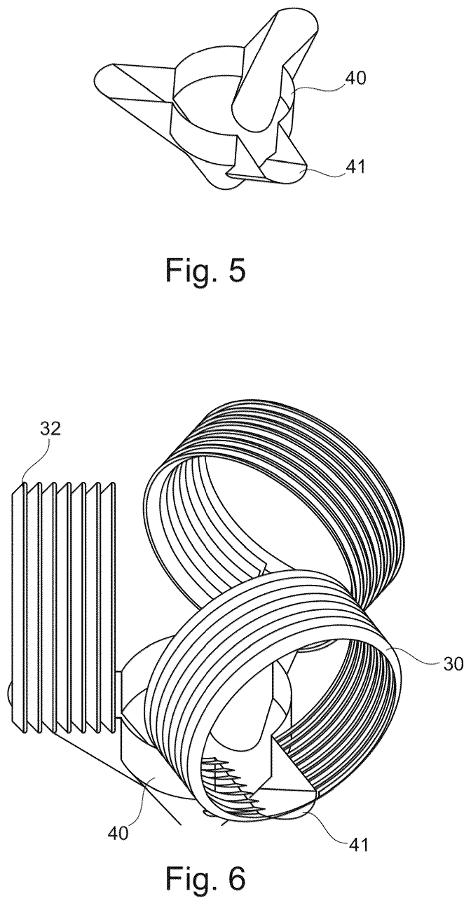

FIG. 5 a grit funnel with chutes; and

FIG. 6 a grit funnel with three guide vane arrangements.

In the following, referring to FIG. 1, the fundamental principle of a vertical roller mill is described on the one hand and on the other hand the idea according to the invention is set out.

In FIG. 1 a highly simplified illustration of a vertical roller mill 20 is shown. This has a grinding table 23 on which several grinding rollers 22 roll off. In operation the grinding table 23 is rotated. Comminuted grinding material is placed onto the said table and is comminuted by means of the stationary, rotatably mounted grinding rollers 22. In the embodiment illustrated here only two grinding rollers 22 are indicated.

Above each grinding roller 22 a classifier 12 of a classifier arrangement 10 according to the invention is located.

Each classifier 12 has a rotor 14 that is rotatable about its axis of rotation 16. In the embodiment illustrated here the axes of rotation 16 of the two classifiers 12 are arranged in the same plane and intersect approximately above the center of the grinding table 23.

Surrounding the rotor 14, which can also be referred to as classifier cage, a guide vane arrangement 30 is arranged that has eight guide vanes 32 in the embodiment shown here.

A guide vane arrangement 30 is illustrated separately in FIG. 3. As can be seen, the guide vanes 32 are of ring-shaped design and have an interruption in which guide plates 36 are arranged in the embodiment shown in FIG. 3. Basically, the guide vanes 32 could also describe a full circle or ring. On the whole, the guide vane arrangement 30 has a shape similar to a cylindrical shell. It is arranged around the rotor 14 of each classifier 12 which can also have a cylindrical shape. If the rotor 14 has a different external contour, this external contour can also be replicated by means of the guide vane arrangement 30.

In FIG. 4 different possible cross sections of guide vanes 32 are depicted by way of example. In this case, the cross section has a U- or V-like shape. In the mounted state the open side of the profile 34 is directed inwards, i.e. towards the rotor 14. In the embodiment illustrated here the cross section of the guide vanes 32 can substantially have two flanks 35. As can be seen, the flanks can be designed of identical size but can also be different in sizes or lengths. Likewise, it is not absolutely necessary that the cross section is of symmetrical design but it can be designed with one flank 35 that is considerably longer. As shown in FIG. 4, it also possible that the cross section is of triangular shape.

As can be seen, in particular in the overall view of FIG. 1 and FIG. 2, the guide vanes 32 can be arranged in different ways. For example, as in FIG. 1 with an inclined side of the guide vanes 32 facing in the direction of the grinding table 23 or in the opposite direction as shown in FIG. 2. Together with the different profiles 34 as depicted in FIG. 4 this can have a different effect on the process gas flows that are present inside the roller mill 20.

In FIG. 3 guide plates 36, the function of which will be explained in greater detail in the following, are arranged in a recess or interruption of the guide vanes 32 of the guide vane arrangement 30.

In FIG. 5 a grit funnel 40 is illustrated that has three chutes 41 in this embodiment. By means of the grit funnel 40 grits which were rejected by the classifiers and are also referred to as not sufficiently comminuted particles can be guided back onto the grinding table 23. The opening or interruption in the guide vane arrangement 30 can be used for this purpose. For this reason, the grit funnel 40 is shown with three disposed guide vane arrangements 30 in FIG. 6. These, in turn have an opening that ends in the area of the chutes 41.

In the following, referring in particular to FIG. 1, the basic functioning of a roller mill 20 is described taking the classifier arrangement 10 according to the invention into consideration.

Grinding material to be comminuted is placed onto the grinding table 23 and comminuted by means of the grinding rollers 22. Through a process air flow directed upwards in the direction of the classifiers 12 the comminuted grinding material which falls over the grinding table 23 is carried towards the classifier arrangement 10. Through the airflow that can also be referred to as carrier airflow the comminuted grinding material passes through the guide vane arrangements 30 into the classifiers 12 with their rotors 14.

Through rotation of the rotors 14 classification of the comminuted particles or rather the comminuted grinding material takes place. Sufficiently comminuted grinding material can be transported onwards by means of the process gas flow and leaves the vertical roller mill 20 through an outlet provided above the classifier arrangement 10.

Not sufficiently comminuted grinding material is rejected by the rotors 14. It is literally hurled away from the rotors 14. These not sufficiently comminuted particles that are hurled away can be collected by the profile shape of the guide vanes 32 and, due to gravity, slide inside the guide vanes back towards the grinding table 23, i.e. the lower area of the vertical roller mill 20. Depending on the precise embodiment of the profile of the guide vanes 32 the inflow direction of the process gas flow onto the rotor 14 can be influenced.

In the embodiment shown here the guide vanes 32 of the guide vane arrangements 30 have an opening in the lower area, through which the rejected particles which represents insufficiently comminuted grinding material are conveyed via the chutes 41 into the grit funnel 40 and are guided from there back onto the grinding table 23. There they are comminuted again and, once more are guided by the process gas flow to the classifier arrangement 10.

Additionally or optionally, it is possible to provide guide plates 36 in the interruption of the guide vane arrangement 30. These guide plates serve to guide the process gas flow present in the interior of the mill and also achieve an optimum incident flow onto the rotor 14 in the recess or interruption of the guide vane arrangement 30.

Thus, by means of the classifier arrangement according to the invention an efficient classification of comminuted grinding material is rendered possible.

1-14. (canceled)

15. A classifier arrangement for a vertical roller mill,
having at least two classifiers,
wherein each classifier has an active rotor that is rotatable about an axis of rotation,
wherein the axis of rotation is aligned at least at an angle of 50° to the vertical,
wherein around each classifier a guide vane arrangement is provided at least partially surrounding the said classifier,
wherein each guide vane arrangement has at least one guide vane,
wherein the guide vane has an open profile towards the axis of rotation of the classifier,
wherein the axes of rotation are aligned with respect to each other and, in particular have a common point of intersection or intersection area.

16. The classifier arrangement according to claim 15,
wherein the classifiers have a substantially identical, in particular cylindrical shape.

17. The classifier arrangement according to claim 15,
wherein the axis of rotation has a maximum angle of 20° to the horizontal.

18. The classifier arrangement according to claim 15,
wherein the guide vanes are arranged in a ring-shaped manner around the axis of rotation.

19. The classifier arrangement according to claim 15,
wherein the guide vanes have a V- or U-like cross section.

20. The classifier arrangement according to claim 15,
wherein the guide vanes have at least two flanks, one of which is of longer design.

21. The classifier arrangement according to claim 15,
wherein the guide vanes of the guide vane arrangement have an interruption and in this interruption guide plates are arranged substantially transversely to the guide vanes.

22. The classifier arrangement according to claim 15,
wherein at least three guide vanes per guide vane arrangement are provided which each have a distance between two adjacent guide vanes.

23. A vertical roller mill,
whereby a classifier arrangement according to claim 15.

24. The vertical roller mill according to claim 23,
wherein the number of classifiers of the classifier arrangement corresponds to the number of rollers provided for active grinding.

25. The vertical roller mill according to claim 23,
wherein the classifiers of the classifier arrangement are arranged in a star-shaped manner in the mill housing, in particular at the same distance to each other.

26. The vertical roller mill according to claim 23,
wherein a common grit funnel is provided which has chutes for each classifier.

27. The vertical roller mill according to claim 23,
wherein the interruptions in the guide vane arrangement are aligned towards the grinding chamber.
